(19) United States
(12) Patent Application Publication
(10) Pub. No.: US 2026/0125242 A1
(43) Pub. Date: May 7, 2026

(54) SELF-PROPELLED ELEVATOR AND METHOD OF SWITCHING PATHS OF SELF-PROPELLED ELEVATOR

(71) Applicants: Mitsubishi Electric Corporation, Tokyo (JP); INSTITUTE OF SCIENCE TOKYO, Tokyo (JP)

(72) Inventors: Yusuke SUGAHARA, Tokyo (JP); Yukio TAKEDA, Tokyo (JP); Takahiro ISHII, Tokyo (JP); Hiro ASAKO, Tokyo (JP); Takeshi MATSUMOTO, Tokyo (JP); Masayuki KAKIO, Tokyo (JP); Daisuke NAKAZAWA, Tokyo (JP)

(73) Assignees: Mitsubishi Electric Corporation, Tokyo (JP); INSTITUTE OF SCIENCE TOKYO, Tokyo (JP)

(21) Appl. No.: 19/118,799

(22) PCT Filed: Oct. 12, 2022
(86) PCT No.: PCT/JP2022/038029

§ 371 Date: Apr. 7, 2025

(51) Int. Cl. B66B 9/00; B66B 9/02

(52) U.S. Cl. CPC B66B 9/003; B66B 9/02

(57) ABSTRACT

A self-propelled elevator according to the present disclosure includes: a car; a first path which is used when the car moves in an up-down direction; a second path which is used when the car moves in a horizontal direction; a first rail which is provided along a longitudinal direction of the first path and along which the car slides; a second rail which is provided along the longitudinal direction of the first path and which guides movement of the car; a third rail which is provided along a longitudinal direction of the second path and along which the car slides; and a switching section which is provided at a position where the first and second paths intersect. The switching section includes a moving rail and a rotating section.

### TECHNICAL FIELD

The present disclosure relates to a self-propelled elevator and to a method of switching paths of the self-propelled elevator.

### BACKGROUND ART

PTL 1 discloses an elevator system. In the elevator system, a car moves in a vertical direction and a horizontal direction.

### CITATION LIST

### Patent Literature

[PTL 1] JP H 6-48672 A

### SUMMARY OF THE INVENTION

### Problem to be Solved by the Invention

In an elevator system that drives a car using a linear motor according to PTL 1, switching from up-down movement to horizontal movement is realized by rotating a rail by 90 degrees. In this system, a passenger-carrying cab need to be prevented from rotating as the rail rotates. Specifically, the system requires means for separating a drive mechanism that corotates with the rail from the cab and rotatably connecting the drive mechanism with respect to the cab, and means for fixing the cab to a hoistway so as to prevent the cab from rotating. In a self-propelled elevator, a car is desirably as light as possible because car mass is directly related to energy consumption. However, since rotatably connecting the drive mechanism and the cab requires making connections using shafts, bearings, and the like and since these components must support the car and a load weight, the components inevitably become larger and heavier.

The present disclosure has been made in order to solve the problem as described above. An object of the present disclosure is to provide a self-propelled elevator capable of up-down movement and horizontal movement while reducing an increase in car mass, and a method of switching paths of the self-propelled elevator.

### Solution to Problem

A self-propelled elevator according to the present disclosure comprises: a car; a first path which is used when the car moves in an up-down direction; a second path which is used when the car moves in a horizontal direction; a first rail which is provided along a longitudinal direction of the first path and along which the car slides; a second rail which is provided along the longitudinal direction of the first path and which guides movement of the car; a third rail which is provided along a longitudinal direction of the second path and along which the car slides; and a switching section which is provided at a position where the first path and the second path intersect, wherein the switching section includes a moving rail and a rotating section, the moving rail can move to a position where the moving rail connects to the first rail when the car moves to the first path and to a position where the car does not come into contact with the moving rail when the car moves to the second path, and the rotating section can rotate and move to a rotation position where the rotating section connects to the second rail when the car moves to the first path and to a rotation position where the rotating section connects to the third rail when the car moves to the second path.

A method according to the present disclosure is switching paths of a self-propelled elevator, the self-propelled elevator including: a car; a first path which is used when the car moves in an up-down direction; a second path which is used when the car moves in a horizontal direction; a first rail which is provided along a longitudinal direction of the first path and along which the car slides; a second rail which is provided along the longitudinal direction of the first path and which guides movement of the car; a third rail which is provided along a longitudinal direction of the second path and along which the car slides; a fourth rail which is provided along the longitudinal direction of the second path above the third rail; and a switching section which is provided at a position where the first path and the second path intersect, the switching section including a moving rail, a first portion rail, and a second portion rail, the moving rail being able to move to a connection position where the moving rail connects to the first rail when the car moves to the first path and to a non-contact position where the car does not come into contact with the moving rail when the car moves to the second path, the first portion rail being able to rotate and move to a rotation position where the first portion rail connects to the second rail when the car moves to the first path and to a rotation position where the first portion rail connects to the third rail when the car moves to the second path, the second portion rail being able to rotate and move to a rotation position where the second portion rail connects to each of the second rail and the first portion rail when the car moves to the first path and to a rotation position where the second portion rail connects to the fourth rail when the car moves to the second path, wherein when switching a movement path of the car from the first path to the second path, switching is performed in an order of: rotating and moving the first portion rail from a rotation position where the first portion rail is parallel to the up-down direction to a rotation position where the first portion rail is parallel to the horizontal direction; subsequently rotating and moving the second portion rail from a rotation position where the second portion rail is parallel to the up-down direction to a rotation position where the second portion rail is parallel to the horizontal direction; and subsequently moving the moving rail from the connection position to the non-contact position, and when switching the movement path of the car from the second path to the first path, switching is performed in an order of: moving the moving rail from the non-contact position to the connection position; subsequently rotating and moving the second portion rail from the rotation position where the second portion rail is parallel to the horizontal direction to the rotation position where the second portion rail is parallel to the up-down direction; and further subsequently rotating and moving the first portion rail from the rotation position where the first portion rail is parallel to the horizontal direction to the rotation position where the first portion rail is parallel to the up-down direction.

### Advantageous Effects of the Invention

According to the present disclosure, a self-propelled elevator capable of up-down movement and horizontal movement while suppressing an increase in car mass and a method of switching paths of the self-propelled elevator can be provided.

### BRIEF DESCRIPTION OF DRAWINGS

FIG. 1 is a diagram of an elevator system to which a hoistway structure of a self-propelled elevator according to a first embodiment is applied.

FIG. 2 is a perspective view for explaining rails and a car of the self-propelled elevator system during up-down movement according to the first embodiment.

FIG. 3 is a rear view of a driving device of the self-propelled elevator according to the first embodiment.

FIG. 4 is a side view of the driving device of the self-propelled elevator according to the first embodiment.

FIG. 5 is a perspective view for explaining the rails and the car of the self-propelled elevator system during horizontal movement according to the first embodiment.

FIG. 6 is a rear view of the driving device of the self-propelled elevator according to the first embodiment.

FIG. 7 is a side view of the driving device of the self-propelled elevator according to the first embodiment.

FIG. 8 is a three-view drawing showing a hoistway structure during an up-down movement of a switching area according to the first embodiment.

FIG. 9 is a three-view drawing showing a hoistway structure during a horizontal direction of the switching area according to the first embodiment.

FIG. 10 is a rear view and a side view showing a first modification according to the first embodiment.

FIG. 11 is a rear view and a side view showing a second modification according to the first embodiment.

FIG. 12 is a rear view during up-down movement of a driving device of a self-propelled elevator according to a second embodiment.

FIG. 13 is a side view during up-down movement of the driving device of the self-propelled elevator according to the second embodiment.

FIG. 14 is a rear view during horizontal movement of the driving device of the self-propelled elevator according to the second embodiment.

FIG. 15 is a side view during horizontal movement of the driving device of the self-propelled elevator according to the second embodiment.

FIG. 16 is a front view and a top view showing a malfunction prevention mechanism as mechanical constraints in the up-down direction according to a third embodiment.

FIG. 17 is a front view and a top view showing a malfunction prevention mechanism as mechanical constraints in the horizontal direction according to the third embodiment.

FIG. 18 is a diagram showing an operation of mechanical constraints on a upper rail and a lower rail by a malfunction prevention mechanism according to the third embodiment.

FIG. 19 is a diagram showing an operation of mechanical constraints on a upper rail and a lower rail by a malfunction prevention mechanism according to the third embodiment.

FIG. 20 is a diagram showing an example of hardware resources of a controller of a car and a controller of a hoistway.

FIG. 21 is a diagram showing another example of hardware resources of the controller of the car and the controller of the hoistway.

### DESCRIPTION OF EMBODIMENTS

Hereinafter, embodiments will be described with reference to the drawings. Common or corresponding elements in each drawing will be denoted by same reference signs and descriptions thereof will be simplified or omitted. In a case where reference is made to an angle in the present disclosure, when there is a major angle and a minor angle whose sum is 360 degrees, an angle being the minor angle will be referred to as a general rule, and when there is an acute angle and an obtuse angle whose sum is 180 degrees, an angle being the acute angle will be referred to as a general rule.

### First Embodiment

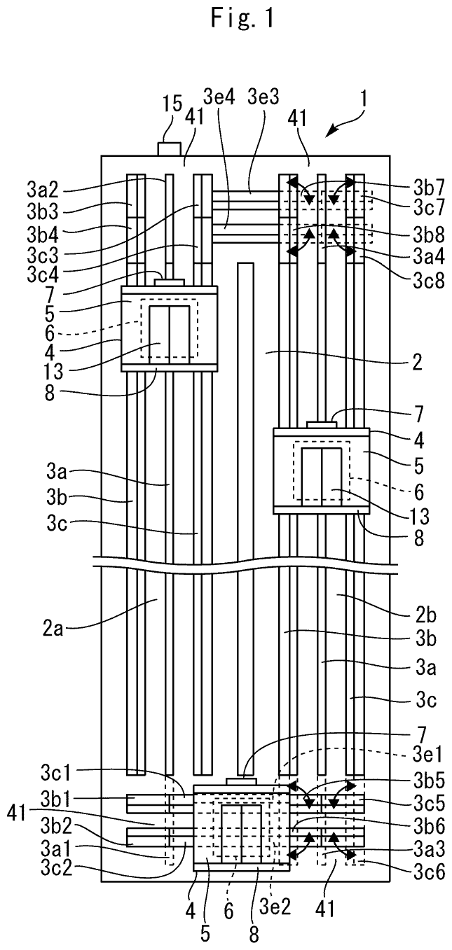

FIG. 1 is a diagram of an elevator system to which a hoistway structure of a self-propelled elevator according to a first embodiment is applied. As shown in FIG. 1, an elevator 1 that is a self-propelled elevator does not require a rope for moving a car 4 up and down. Therefore, a plurality of cars 4 can run in one hoistway 2. As buildings provided with general rope-driven elevators become higher, a proportion of a hoistway to a building increases. Therefore, enabling a plurality of cars 4 to run in one hoistway is effective in terms of reducing an area of the hoistway 2 on a horizontal projection plane.

For example, the elevator 1 is provided in a building. The building has a plurality of floors. In the building, the hoistway 2 is provided so as to span a plurality of floors. In the example shown in FIG. 1, the hoistway 2 is divided into a hoistway 2a and a hoistway 2b. In this example, the travel direction is a vertical direction. The hoistway 2b is provided parallel to the hoistway 2a. The car 4 can move in an up-down direction in the hoistway 2a. The car 4 can move in the up-down direction in the hoistway 2b. In the present disclosure, the “up-down direction” refers to a direction of a vertical line. The car 4 can also move in a horizontal direction. In the present disclosure, the “horizontal direction” refers to a specific direction that is parallel to a horizontal plane. A switching area 41 is a portion where the car 4 is switched between up-down movement and horizontal movement. The example shown in FIG. 1 is provided with four switching areas 41 including the switching area 41 above the hoistway 2a, the switching area 41 above the hoistway 2b, the switching area 41 below the hoistway 2a, and the switching area 41 below the hoistway 2b. The car 4 can move in the horizontal direction between the switching area 41 above the hoistway 2a and the switching area 41 above the hoistway 2b. The car 4 can move in the horizontal direction between the switching area 41 below the hoistway 2a and the switching area 41 below the hoistway 2b.

Three rails are arranged in the hoistway 2a. A drive rail 3a is arranged at the center of the hoistway 2a. A guide rail 3b is arranged to the left of the drive rail 3a. A guide rail 3c is arranged to the right of the drive rail 3a. A longitudinal direction of each of the drive rail 3a and the guide rails 3b and 3c is parallel to the vertical direction.

Three rails are arranged in the hoistway 2b. The drive rail 3a is arranged at the center of the hoistway 2b. The guide rail 3b is arranged to the left of the drive rail 3a. The guide rail 3c is arranged to the right of the drive rail 3a. The longitudinal direction of each of the drive rail 3a and the guide rails 3b and 3c is parallel to the vertical direction.

A moving rail 3a1 is arranged in the switching area 41 below the hoistway 2a. The moving rail 3a1 is arranged on an extension of the drive rail 3a. The moving rail 3al is provided so as to be movable by an actuator (not illustrated) from a position on the extension of the drive rail 3a.

An upper rail 3b1, a lower rail 3b2, an upper rail 3c1, and a lower rail 3c2 are arranged in the switching area 41 below the hoistway 2a. The upper rail 3b1 and the lower rail 3b2 are on an extension of the guide rail 3b. The upper rail 3c1 and the lower rail 3c2 are on an extension of the guide rail 3c. The upper rail 3b1, the lower rail 3b2, the upper rail 3c1, and the lower rail 3c2 are each provided so as to be rotatable by an actuator (not illustrated). The upper rail 3b1, the lower rail 3b2, the upper rail 3c1, and the lower rail 3c2 are each provided so as to be able to maintain an attitude a longitudinal direction of which is parallel to the vertical direction. The upper rail 3b1, the lower rail 3b2, the upper rail 3c1, and the lower rail 3c2 are each provided so as to be able to maintain an attitude the longitudinal direction of which is parallel to the horizontal direction.

A moving rail 3a2 is arranged in the switching area 41 above the hoistway 2a. The moving rail 3a2 is arranged on an extension of the drive rail 3a. The moving rail 3a2 is provided so as to be movable by an actuator (not illustrated) from a position on the extension of the drive rail 3a.

An upper rail 3b3, a lower rail 3b4, an upper rail 3c3, and a lower rail 3c4 are arranged in the switching area 41 above the hoistway 2a. The upper rail 3b3 and the lower rail 3b4 are on an extension of the guide rail 3b. The upper rail 3c3 and the lower rail 3c4 are on an extension of the guide rail 3c. The upper rail 3b3, the lower rail 3b4, the upper rail 3c3, and the lower rail 3c4 are each provided so as to be rotatable by an actuator (not illustrated). The upper rail 3b3, the lower rail 3b4, the upper rail 3c3, and the lower rail 3c4 are each provided so as to be able to maintain an attitude a longitudinal direction of which is parallel to the vertical direction. The upper rail 3b3, the lower rail 3b4, the upper rail 3c3, and the lower rail 3c4 are each provided so as to be able to maintain an attitude the longitudinal direction of which is parallel to the horizontal direction.

A moving rail 3a3 is arranged in the switching area 41 below the hoistway 2b. The moving rail 3a3 is arranged on an extension of the drive rail 3a. The moving rail 3a3 is provided so as to be movable by an actuator (not illustrated) from a position on the extension of the drive rail 3a.

An upper rail 3b5, a lower rail 3b6, an upper rail 3c5, and a lower rail 3c6 are arranged in the switching area 41 below the hoistway 2b. The upper rail 3b5 and the lower rail 3b6 are on an extension of the guide rail 3b. The upper rail 3c5 and the lower rail 3c6 are on an extension of the guide rail 3c. The upper rail 3b5, the lower rail 3b6, the upper rail 3c5, and the lower rail 3c6 are each provided so as to be rotatable by an actuator (not illustrated). The upper rail 3b5, the lower rail 3b6, the upper rail 3c5, and the lower rail 3c6 are each provided so as to be able to maintain an attitude a longitudinal direction of which is parallel to the vertical direction. The upper rail 3b5, the lower rail 3b6, the upper rail 3c5, and the lower rail 3c6 are each provided so as to be able to maintain an attitude the longitudinal direction of which is parallel to the horizontal direction.

A moving rail 3a4 is arranged in the switching area 41 above the hoistway 2b. The moving rail 3a4 is arranged on an extension of the drive rail 3a. The moving rail 3a4 is provided so as to be movable by an actuator (not illustrated) from a position on the extension of the drive rail 3a.

An upper rail 3b7, a lower rail 3b8, an upper rail 3c7, and a lower rail 3c8 are arranged in the switching area 41 above the hoistway 2b. The upper rail 3b7 and the lower rail 3b8 are on an extension of the guide rail 3b. The upper rail 3c7 and the lower rail 3c8 are on an extension of the guide rail 3c. The upper rail 3b7, the lower rail 3b8, the upper rail 3c7, and the lower rail 3c8 are each provided so as to be rotatable by an actuator (not illustrated). The upper rail 3b7, the lower rail 3b8, the upper rail 3c7, and the lower rail 3c8 are each provided so as to be able to maintain an attitude a longitudinal direction of which is parallel to the vertical direction. The upper rail 3b7, the lower rail 3b8, the upper rail 3c7, and the lower rail 3c8 are each provided so as to be able to maintain an attitude the longitudinal direction of which is parallel to the horizontal direction.

A horizontal rail 3e1 and a horizontal rail 3e2 are each arranged below the hoistway 2 with a longitudinal direction thereof being the horizontal direction. The horizontal rail 3e1 and the horizontal rail 3e2 are arranged so as to connect the switching area 41 below the hoistway 2a and the switching area 41 below the hoistway 2b with each other.

One side of the horizontal rail 3e1 is provided so as to be smoothly connectable to the upper rail 3c1 when the longitudinal direction of the upper rail 3c1 is the horizontal direction. Another side of the horizontal rail 3e1 is provided so as to be smoothly connectable to the upper rail 3b5 when the longitudinal direction of the upper rail 3b5 is the horizontal direction.

One side of the horizontal rail 3e2 is provided so as to be smoothly connectable to the lower rail 3c2 when the longitudinal direction of the lower rail 3c2 is the horizontal direction. Another side of the horizontal rail 3e2 is provided so as to be smoothly connectable to the lower rail 3b6 when the longitudinal direction of the lower rail 3b6 is the horizontal direction.

A horizontal rail 3e3 and a horizontal rail 3e4 are each arranged above the hoistway 2 with the longitudinal direction thereof being the horizontal direction. The horizontal rail 3e3 and the horizontal rail 3e4 are arranged so as to connect the switching area 41 above the hoistway 2a and the switching area 41 above the hoistway 2b with each other.

One side of the horizontal rail 3e3 is provided so as to be smoothly connectable to the upper rail 3c3 when the longitudinal direction of the upper rail 3c3 is the horizontal direction. Another side of the horizontal rail 3e3 is provided so as to be smoothly connectable to the upper rail 3b7 when the longitudinal direction of the upper rail 3b7 is the horizontal direction.

One side of the horizontal rail 3e4 is provided so as to be smoothly connectable to the lower rail 3c4 when the longitudinal direction of the lower rail 3c4 is the horizontal direction. Another side of the horizontal rail 3e4 is provided so as to be smoothly connectable to the lower rail 3b8 when the longitudinal direction of the lower rail 3b8 is the horizontal direction.

The elevator 1 includes two or more cars 4. For example, the elevator 1 may include three or more cars 4 with respect to the hoistway 2a and the hoistway 2b.

Each car 4 includes a cab 5, a driving device 6, and a controller 7.

The cab 5 has, therein, a space for loading articles to be carried. The cab 5 has a car platform 8. The car platform 8 is a bottom surface of the cab 5. The car platform 8 supports a load of the articles to be carried which are loaded onto the cab 5.

The driving device 6 is a device which generates a drive force for moving the cab 5 in the up-down direction and a drive force for moving the cab 5 in the horizontal direction. The driving device 6 is provided on a rear surface side of the cab 5 on an opposite side to a hall where users board and alight from the cab 5. The driving device 6 can grasp the drive rail 3a using a pair of wheels 21a and a pair of drive wheels 21b to be described later. The driving device 6 moves the cab 5 up and down by a friction force between the driving device 6 and the drive rail 3a.

The controller 7 is a portion which controls motions of the car 4. For example, the controller 7 is positioned in an upper part of the cab 5. For example, the controller 7 is positioned in a lower part of the car 4. For example, the controller 7 is positioned at a location other than an upper part and a lower part in the car 4. For example, the controller 7 is positioned by being divided into a plurality of portions.

In this example, the cab 5 moves up and down in the hoistway 2a or the hoistway 2b. The cab 5 moves between the hoistway 2a and the hoistway 2b above or below the hoistway 2.

For example, in the hoistway 2a, the cab 5 reaches the switching area 41 in the up-down direction and the horizontal direction by ascending while being guided by the drive rail 3a and the guide rails 3b and 3c via the driving device 6.

Subsequently, each of the lower rails 3b4, 3c4, 3b8, and 3c8 and the upper rails 3b3, 3c3, 3b7, and 3c7 rotates 90 degrees. In addition, the moving rails 3a2 and 3a4 move to positions where movements of the cab 5 and the driving device 6 are not obstructed. Subsequently, the cab 5 moves in the horizontal direction while being guided by the upper rails 3b3, 3c3, 3b7, and 3c7, the lower rails 3b4, 3c4, 3b8, and 3c8, and the horizontal rails 3e3 and 3e4 via the driving device 6 and reaches the switching area 41 in the up-down direction and the horizontal direction above the hoistway 2b.

Subsequently, each of the lower rails 3b4, 3c4, 3b8, and 3c8 and the upper rails 3b3, 3c3, 3b7, and 3c7 rotates 90 degrees and the longitudinal direction of each rail returns to being parallel to the up-down direction. In addition, the moving rails 3a2 and 3a4 move to positions where the rails connect to the drive rail 3a. Subsequently, the cab 5 descends while being guided by the drive rail 3a and the guide rails 3b and 3c via the driving device 6 in the hoistway 2b.

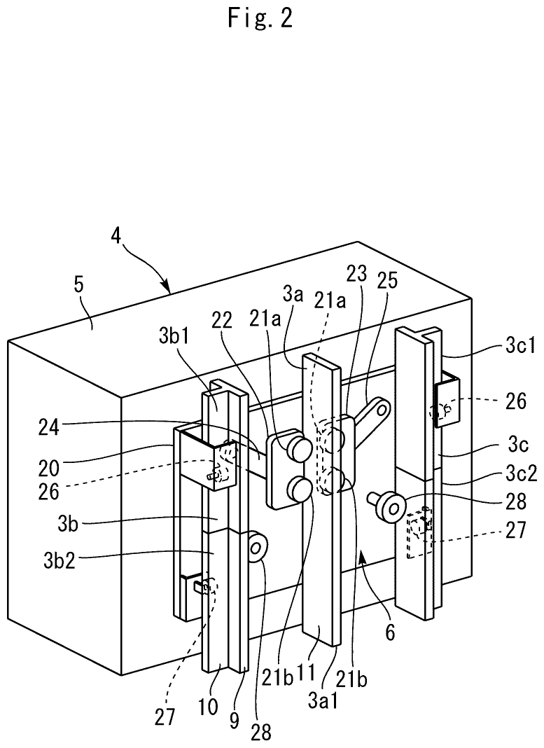

Next, the rails and the car 4 will be described with reference to FIG. 2. FIG. 2 is a perspective view for explaining the rails and the car 4 of the self-propelled elevator system during up-down movement according to the first embodiment. In this example, shapes of lateral cross sections of the drive rail 3a and the moving rail 3al are rectangular. In the present disclosure, a “lateral cross section” is a cross section that is perpendicular to the longitudinal direction. The drive rail 3a and the moving rail 3a1 have a guide surface 11. The guide surface 11 is at least one of a front surface and a rear surface of the drive rail 3a and the moving rail 3a1 which are rectangular. The moving rail 3a1 can replace the drive rail 3a in the switching area 41. The upper rail 3b1 and the lower rail 3b2 can replace the guide rail 3b in the switching area 41. The upper rail 3c1 and the lower rail 3c2 can replace the guide rail 3c in the switching area 41. A shape of a lateral cross section of each of the guide rail 3b and the guide rail 3c is a T-shape. Each of the guide rail 3b and the guide rail 3c has a bottom panel 9 and a guide plate 10. The bottom panel 9 is a surface that is perpendicular to the rear surface of the car 4. In this example, the guide plate 10 is a plate which is perpendicular to the bottom panel 9. The guide plate 10 is a plate-like portion which is arranged parallel to the car 4 from the bottom panel 9. The upper rails 3b1 and 3c1 and the lower rails 3b2 and 3c2 have similar lateral cross-sectional shapes to the guide rails 3b and 3c.

The cab 5 has a car door 13. In this example, the car door 13 is provided on an opposite side to the driving device 6 in the cab 5. Although not illustrated, the car 4 may have a brake, a safety gear device, and the like in addition to the driving device 6.

The brake is provided so that a braking force can be applied to the car 4 when the car 4 is moving or standing still. The safety gear device is provided so that the car 4 can be brought to a standstill by force when the car 4 is in free fall. Although a case where the car door 13 and the driving device 6 are provided on opposite sides in the cab 5 has been shown, the car door 13 and the driving device 6 need not necessarily be on opposite sides.

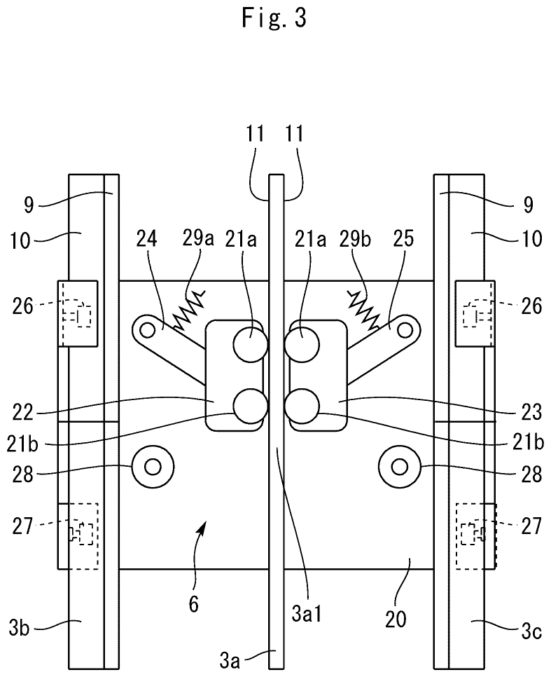

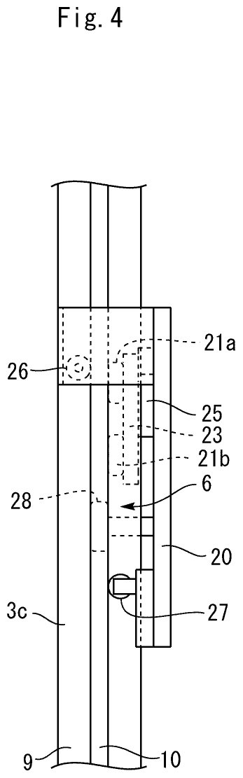

Next, the driving device 6 will be described with reference to FIGS. 2 to 4. FIG. 3 is a rear view of the driving device 6 of the self-propelled elevator according to the first embodiment. FIG. 4 is a side view of the driving device 6 of the self-propelled elevator according to the first embodiment.

In this example, the driving device 6 has a pair of wheels 21a and a pair of drive wheels 21b. One of the pair of wheels 21a comes into contact with one of a pair of guide surfaces 11. One of the pair of drive wheels 21b comes into contact with the one of the pair of guide surfaces 11 below the one of the pair of wheels 21a. The other of the pair of wheels 21a comes into contact with the other of the pair of guide surfaces 11. The other of the pair of drive wheels 21b comes into contact with the other of the pair of guide surfaces 11 below the other of the pair of wheels 21a.

The one and the other of the pair of wheels 21a are arranged at symmetrical positions with respect to both guide surfaces 11. The one and the other of the pair of drive wheels 21b are arranged at symmetrical positions with respect to both guide surfaces 11. While a case where the pair of wheels 21a and the pair of drive wheels 21b are arranged at bilaterally symmetrical positions will be described, the pair of wheels 21a and the pair of drive wheels 21b need not necessarily be bilaterally symmetrical.

Although not illustrated, the driving device 6 has at least one motor for moving the drive wheels 21b.

Note that the arrangements of the wheels 21a and the drive wheels 21b are not limited to this example. Two drive wheels 21b may be provided on the one of the pair of guide surfaces 11. All four wheels including the pair of wheels 21a and the pair of drive wheels 21b may be drive wheels. The total number of the wheels 21a and the drive wheels 21b is not limited to four and may be two or six or more.

In this example, a first pressing-force averaging link 22 has a square shape. The first pressing-force averaging link 22 is arranged on a side of the one of the pair of guide surfaces 11 as a wheel support link. The first pressing-force averaging link 22 rotatably supports the one of the pair of wheels 21a and the one of the pair of drive wheels 21b. In the first pressing-force averaging link 22, an opposite side to the drive rail 3a is rotatably supported with respect to a first self-boosting link 24.

In this example, a second pressing-force averaging link 23 has a square shape. The second pressing-force averaging link 23 is arranged on a side of the other of the pair of guide surfaces 11 as a wheel support link. The second pressing-force averaging link 23 rotatably supports the other of the pair of wheels 21a and the other of the pair of drive wheels 21b. In the second pressing-force averaging link 23, an opposite side to the drive rail 3a is rotatably supported with respect to a second self-boosting link 25.

The first self-boosting link 24 is positioned diagonally at an angle of 45 degrees or less with respect to the horizontal direction. One end of the first self-boosting link 24 is rotatably coupled to the first pressing-force averaging link 22 on an opposite side to the drive rail 3a. Another end of the first self-boosting link 24 is rotatably supported with respect to a support body 20. In the illustrated example, the support body 20 has a plate shape.

The second self-boosting link 25 is arranged diagonally at an angle of 45 degrees or less with respect to the horizontal direction. One end of the second self-boosting link 25 is rotatably coupled to the second pressing-force averaging link 23 on an opposite side to the drive rail 3a. Another end of the second self-boosting link 25 is rotatably supported with respect to the support body 20.

The driving device 6 is provided on the support body 20. The support body 20 directly or indirectly supports the cab 5.

In the illustrated example, one end of a release spring 29a is coupled to the first self-boosting link 24. Another end of the release spring 29a is coupled to the support body 20. One end of a release spring 29b is coupled to the second self-boosting link 25. Another end of the release spring 29b is coupled to the support body 20. Not only in the illustrated example, one end of the release spring 29a may be coupled to the first pressing-force averaging link 22. The one end of the release spring 29b may be coupled to the second pressing-force averaging link 23.

In this example, one set of first tilt prevention rollers 26 is arranged above and near both left and right ends of the support body 20. One of the first tilt prevention rollers 26 comes into contact with a surface on an opposite side to the car 4 of the guide plate 10 of the guide rail 3b. The other of the first tilt prevention rollers 26 comes into contact with a surface on an opposite side to the car 4 of the guide plate 10 of the guide rail 3c.

The first tilt prevention rollers 26 may have a structure that enables an orientation of the roller to be changed to a travel direction of the car 4. Alternatively, the first tilt prevention rollers 26 may have a structure that can travel in any direction by means of a spherical roller.

In this example, one set of second tilt prevention rollers 27 is arranged below and near both left and right ends of the support body 20. One of the second tilt prevention rollers 27 comes into contact with a surface on a side of the car 4 of the guide plate 10 of the guide rail 3b. The other of the second tilt prevention rollers 27 comes into contact with a surface on a side of the car 4 of the guide plate 10 of the guide rail 3c.

The second tilt prevention rollers 27 may have a structure that enables an orientation of the roller to be changed in the travel direction of the car 4. Alternatively, the second tilt prevention rollers 27 may have a structure that can travel in any direction by means of a spherical roller.

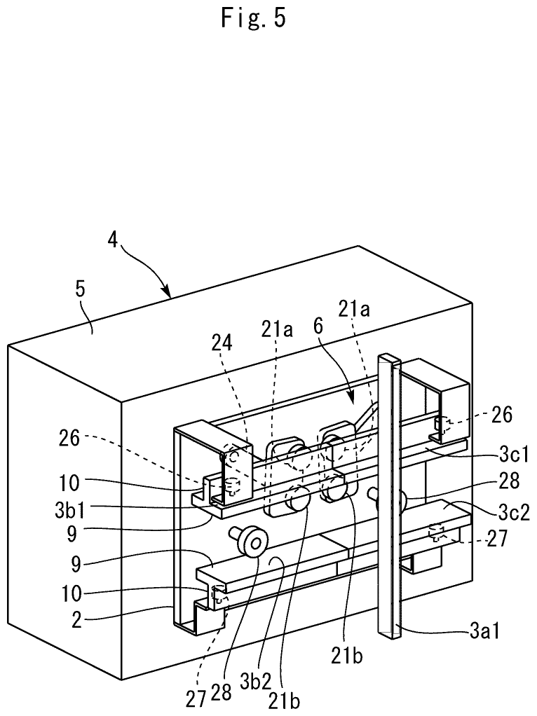

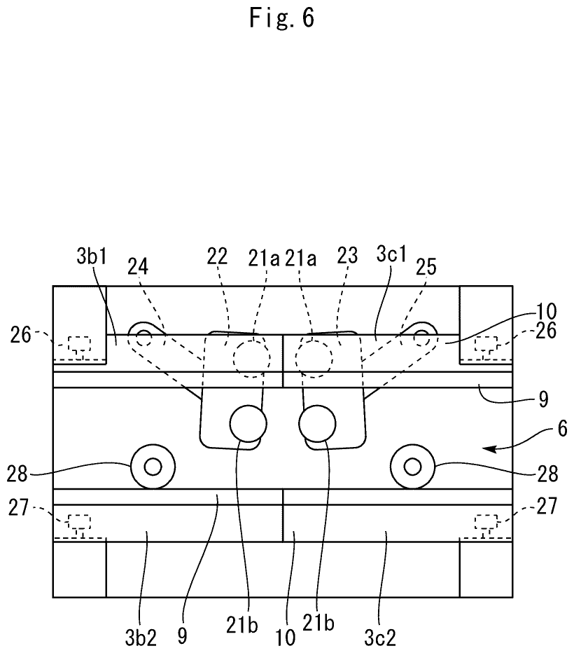

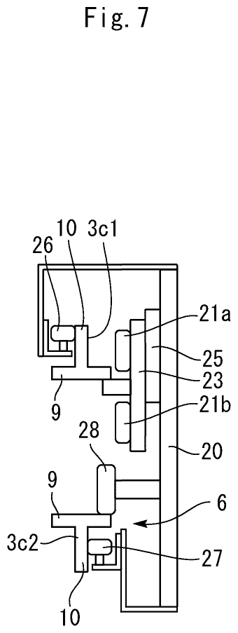

FIGS. 5 to 7 show a case where the car 4 moves in the horizontal direction. FIG. 5 is a perspective view for explaining the rails and the car 4 of the self-propelled elevator system during horizontal movement according to the first embodiment. FIG. 6 is a rear view of the driving device 6 of the self-propelled elevator according to the first embodiment. FIG. 7 is a side view of the driving device 6 of the self-propelled elevator according to the first embodiment.

FIGS. 5 to 7 represent a state where each of the upper rails 3b1 and 3c1 and the lower rails 3b2 and 3c2 has rotated 90 degrees from the state shown in FIGS. 2 to 4. The upper rails 3b1 and 3c1 are arranged so that the bottom panels 9 are on a lower side and the guide plates 10 are on an upper side. Conversely, the lower rails 3b2 and 3c2 are arranged so that the bottom panels 9 are on an upper side and the guide plates 10 are on a lower side. In this case, the moving rail 3a1 has moved to a position that does not come into contact or interfere with any of the upper rails 3b1 and 3c1, the lower rails 3b2 and 3c2, the car 4, and the driving device 6. Therefore, the pair of wheels 21a and the pair of drive wheels 21b are not in contact with the moving rail 3a1. In addition, the pair of first tilt prevention rollers 26 comes into contact with a surface on an opposite side to the car 4 of the guide plates 10 of the upper rails 3b1 and 3c1. The pair of second tilt prevention rollers 27 comes into contact with a surface on a side of the car 4 of the guide plates 10 of the lower rails 3b2 and 3c2.

The driving device 6 includes a pair of horizontal movement drive wheels 28 mounted to the support body 20. The horizontal movement drive wheels 28 are arranged at positions that come into contact with upper surfaces of the bottom panels 9 of the lower rails 3b2 and 3c2 and the like. The horizontal movement drive wheels 28 are driven by a motor (not illustrated). The horizontal movement drive wheels 28 move the car 4 in the horizontal direction. The motor that drives the horizontal movement drive wheels 28 may be shared with the motor that drives the drive wheels 21b.

An operation of the hoistway and an operation of the car 4 when the car 4 descends the hoistway 2a, the car 4 transitions to horizontal movement in the switching area 41 below the hoistway 2a, the car 4 moves along the horizontal rails 3e1 and 3e2, the car 4 transitions to up-down movement in the switching area 41 below the hoistway 2b, and the car 4 ascends the hoistway 2b will now be described in detail.

First, a state of the driving device 6 when the car 4 descends the hoistway 2a will be described. When the car 4 descends the hoistway 2a, the pair of wheels 21a and the pair of drive wheels 21b are pressed against the guide surface 11 of the drive rail 3a by the first self-boosting link 24 and the second self-boosting link 25. The car 4 descends as the pair of drive wheels 21b is driven. At this point, both the first tilt prevention roller 26 and the second tilt prevention roller 27 are in a state of contact with the guide rails 3b and 3c. The first tilt prevention roller 26 and the second tilt prevention roller 27 prevent a rotation of the car 4 around its axis in the left-right direction. At this point, the horizontal movement drive wheels 28 are not in contact with any of the rails. The car descends in this state and stops at the switching area 41.

Next, a transition from the up-down movement to the horizontal movement in the switching area 41 will be described. An order of operation is as follows.
(1) Confirm that the car 4 has stopped at a predetermined position in the switching area 41 below the hoistway 2a.
(2) Each of the lower rail 3b2 and the lower rail 3c2 rotates 90 degrees. At this point, each of the lower rail 3b2 and the lower rail 3c2 comes into contact with the horizontal movement drive wheel 28. In addition, the lower rail 3b6 and the lower rail 3c6 in the hoistway 2b rotate in a similar manner.
(3) Each of the upper rail 3b1 and the upper rail 3c1 rotates 90 degrees. At this point, as shown in FIG. 7, the bottom panel 9 of the upper rail 3b1 comes into contact with the first self-boosting link 24 or the first pressing-force averaging link 22 and presses down the first self-boosting link 24 or the first pressing-force averaging link 22. In addition, the bottom panel 9 of the upper rail 3cl comes into contact with the second self-boosting link 25 or the second pressing-force averaging link 23 and pushes down the second self-boosting link 25 or the second pressing-force averaging link 23. This operation causes a pressing force of the pair of wheels 21a and the pair of drive wheels 21b against the moving rail 3a1 to become zero and the pair of wheels 21a and the pair of drive wheels 21b move away from the moving rail 3a1. Furthermore, the upper rail 3b5 and the upper rail 3c5 in the hoistway 2b rotate in a similar manner.
(4) The moving rail 3a1 moves toward the back of the hoistway 2a. Accordingly, a path for horizontal movement of the car 4 is secured. In addition, the moving rail 3a3 in the hoistway 2b moves in a similar manner.
(5) The motor of the driving device 6 drives the horizontal movement drive wheels 28 and the car 4 moves in the horizontal direction from the switching area 41 below the hoistway 2a to the switching area 41 below the hoistway 2b.
(6) Confirm that the car 4 has stopped at a predetermined position in the switching area 41 below the hoistway 2b.
(7) The moving rail 3a3 moves toward the front of the hoistway 2b or, in other words, in a direction of the car door 13.
(8) Each of the upper rail 3b5 and the upper rail 3c5 rotates 90 degrees. The direction of rotation at this point is the direction in which the longitudinal directions of the upper rail 3b5 and the upper rail 3c5 change from the horizontal direction to the up-down direction. When the upper rail 3b5 and the upper rail 3c5 return to their original positions, the depression by the upper rail 3b5 with respect to the first self-boosting link 24 or the first pressing-force averaging link 22 is released and the depression by the upper rail 3c5 with respect to the second self-boosting link 25 or the second pressing-force averaging link 23 is released. As a result, the release springs 29a and 29b cause the pair of wheels 21a and the pair of drive wheels 21b to come into contact with the moving rail 3a3.
(9) Each of the lower rail 3b6 and the lower rail 3c6 rotates 90 degrees. The direction of rotation at this point is the direction in which the longitudinal directions of the lower rail 3b6 and the lower rail 3c6 change from the horizontal direction to the up-down direction. At this point, since the lower rails 3b6 and 3c6 and the horizontal movement drive wheels 28 are separated, a dead load of the car 4 acts to press the pair of wheels 21a and the pair of drive wheels 21b against the moving rail 3a3 with a great force via the first self-boosting link 24 and the second self-boosting link 25. Therefore, the car 4 is held by a force of friction.
(10) The motor in the driving device 6 drives the pair of drive wheels 21b and moves the car 4 upward.

While a transition operation in the switching areas 41 below the hoistways 2a and 2b has been described above, a transition operation can be performed in a similar procedure in the switching areas 41 above the hoistways 2a and 2b. Rotations of the lower rails 3b2, 3c2, 3b4, 3c4, 3b6, 3c6, 3b8, and 3c8 and the upper rails 3b1, 3c1, 3b3, 3c3, 3b5, 3c5, 3b7, and 3c7 and movements of the moving rails 3a1, 3a2, 3a3, and 3a4 are performed by using a motor installed on the side of the hoistway 2 as a drive source. Accordingly, the weight of the car 4 can be reduced and energy saving can be achieved.

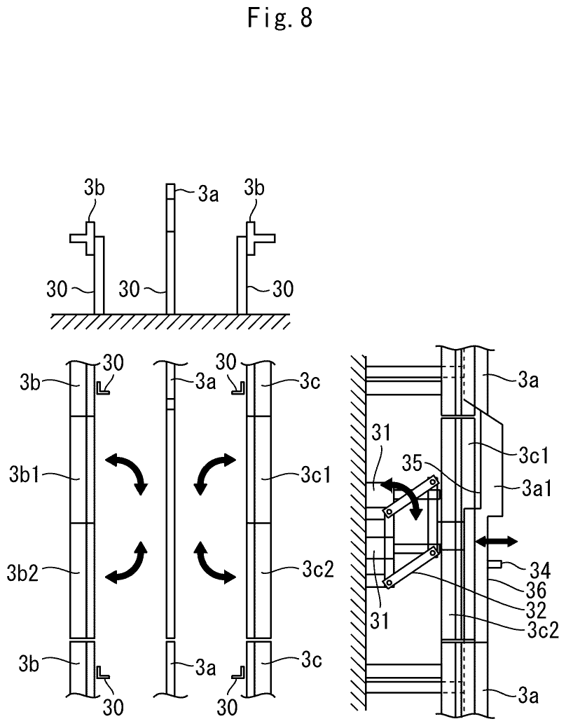

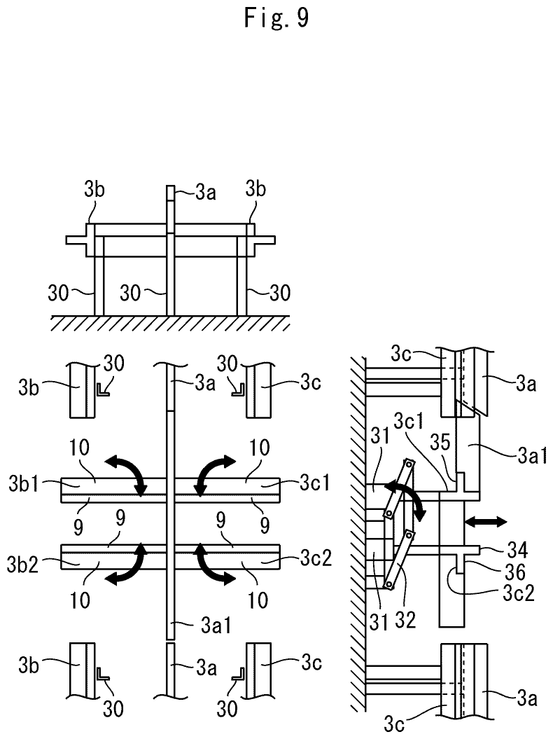

Next, a detailed operation of the rails in the switching area 41 will be described with reference to FIGS. 8 and 9. FIG. 8 is a three-view drawing showing a hoistway structure during an up-down movement of the switching area 41 according to the first embodiment. FIG. 9 is a three-view drawing showing a hoistway structure during a horizontal direction of the switching area 41 according to the first embodiment.

The guide rails 3b and 3c are fixed in the hoistway 2 by a rail support member 30 above and below the switching area 41 where the rail rotates and moves. The drive rail 3a is fixed in the hoistway 2 by the rail support member 30. For example, the rail support member 30 is an L-shaped plate-like or rod-like member. On the other hand, the rail support member 30 which supports each of the upper rails 3b1 and 3c1 and the lower rails 3b2 and 3c2 that are guide rails in the switching area 41 is directly or indirectly coupled to a motor 31. Each of the upper rails 3b1 and 3c1 and the lower rails 3b2 and 3c2 is capable of rotating with a longitudinal direction of the rail support member 30 as an axis.

In addition, in a four-section link 32 one side of which is fixed to the hoistway 2, the moving rail 3a1 is fixed to a link that is the opposite side to the fixed link. By adopting such a configuration, the moving rail 3a1 can be moved in a direction toward the front and in a direction toward the back of the hoistway 2 by rotating links of the four-section link 32 using a motor (not illustrated). Accordingly, movement paths of the car 4 and the driving device 6 can be secured.

In the example shown in FIGS. 8 and 9, the moving rail 3a1 is provided with irregularities so that the pair of first tilt prevention rollers 26, the pair of second tilt prevention rollers 27, and the horizontal movement drive wheels 28 do not fall into the gap between the guide rails. Specifically, the moving rail 3a1 is provided with a convex part 34, a concave part 35, and a concave part 36. The convex part 34 coincides with a position of an upper surface of the bottom panel 9 on a side of the car 4 in the gap between the lower rail 3b2 and the lower rail 3c2. Accordingly, since the convex part 34 fills the gap between the lower rail 3b2 and the lower rail 3c2, the horizontal movement drive wheel 28 can pass smoothly. The position of the concave part 35 coincides with a surface of the guide plate 10 on a wall side of the hoistway 2 of the upper rails 3b1 and 3c1. Providing the concave part 35 enables the pair of first tilt prevention rollers 26 to pas smoothly. The position of the concave part 36 coincides with a surface of the guide plate 10 on a side of the car 4 of the lower rails 3b2 and 3c2. Providing the concave part 36 enables the pair of second tilt prevention rollers 27 to pas smoothly.

In the present disclosure, each of the hoistways 2a and 2b corresponds to a “first path” that is used when the car 4 moves in the up-down direction. In addition, the path used when the car 4 moves in the horizontal direction is called “second path”.

The self-propelled elevator according to the present disclosure includes: a first rail (drive rail 3a) which is provided along the longitudinal direction of the first path and along which the car 4 slides; a second rail (guide rails 3b and 3c) which is provided along the longitudinal direction of the first path and which guides movement of the car 4; a third rail (horizontal rail 3e2) which is provided along the longitudinal direction of the second path and along which the car 4 slides; and a switching section (switching area 41) which is provided at a position where the first and second paths intersect.

Since the four switching sections (switching areas 41) in FIG. 1 are configured in a similar manner, the description of one switching area 41 is shared by or similar to the description of the other switching areas 41.

Each switching section (switching area 41) includes the moving rail 3a1 and a rotating section (lower rails 3b2 and 3c2).

The moving rail 3a1 can move to a position where the moving rail 3a1 connects to the first rail (drive rail 3a) when the car 4 moves to the first path and to a position where the car 4 does not come into contact with the moving rail 3a1 when the car 4 moves to the second path.

The rotating section (lower rails 3b2 and 3c2) can rotate and move to a rotation position where the rotating section (lower rails 3b2 and 3c2) connects to the second rail (guide rails 3b and 3c) when the car 4 moves to the first path and to a rotation position where the rotating section (lower rails 3b2 and 3c2) connects to the third rail (horizontal rail 3e2) when the car 4 moves to the second path.

According to the present disclosure, by using a configuration of the hoistway 2 in which the lower rails 3b2 and 3c2 corresponding to guide rails in the switching area 41 are rotated 90 degrees and the moving rail 3a1 corresponding to a drive rail in the switching area 41 is moved from a running path of the car 4, there is no need to rotate the cab 5 and the driving device 6. Therefore, the cab 5 and the driving device 6 can be directly or indirectly fixed. As a result, the structure can be simplified and the weight of the car 4 can be reduced. Reducing the weight of the car 4 enables energy (power) required for movement to be reduced.

A configuration in which the driving device 6 is rotated with respect to the cab 5 requires means for fixing the cab 5 such as inserting pins or the like in order to prevent the cab 5 from rotating. By comparison, with the self-propelled elevator according to the present disclosure, since the driving device 6 is fixed to the cab 5 in a non-rotatable manner, there is no longer the need for pins or other restraints. Accordingly, requirements for high positioning accuracy for pin insertion and the like are eliminated and the difficulty of insertion and removal due to the weight of the car 4 acting on the pins and the like is resolved.

The self-propelled elevator according to the present disclosure may further include a fourth rail (horizontal rail 3e1) provided along the longitudinal direction of the second path above the third rail (horizontal rail 3e2).

The rotating section may include a first portion rail (lower rails 3b2 and 3c2) and a second portion rail (upper rails 3b1 and 3c1).

The first portion rail (lower rails 3b2 and 3c2) can rotate and move to a rotation position where the first portion rail (lower rails 3b2 and 3c2) connects to the second rail (guide rails 3b and 3c) when the car 4 moves to the first path and to a rotation position where the first portion rail (lower rails 3b2 and 3c2) connects to the third rail (horizontal rail 3e2) when the car 4 moves to the second path.

The second portion rail (upper rails 3b1 and 3c1) can rotate and move to a rotation position where the second portion rail (upper rails 3b1 and 3c1) connects to each of the second rail (guide rails 3b and 3c) and the first portion rail (lower rails 3b2 and 3c2) when the car 4 moves to the first path and to a rotation position where the second portion rail (upper rails 3b1 and 3c1) connects to the fourth rail (horizontal rail 3e1) when the car 4 moves to the second path.

During horizontal movement, the car 4 is supported by the first portion rail (lower rails 3b2 and 3c2) and runs on the first portion rail (lower rails 3b2 and 3c2). When the fourth rail (horizontal rail 3e1) and the second portion rail (upper rails 3b1 and 3c1) are provided, a correct attitude of the car 4 can be more reliably maintained with a simple configuration. However, the self-propelled elevator according to the present disclosure need not include the fourth rail (horizontal rail 3e1) and the second portion rail (upper rails 3b1 and 3c1).

In the present disclosure, the car 4 may include a first wheel (wheels 21a and drive wheels 21b) that rolls in contact with one of the guide surfaces of the first rail (drive rail 3a) when the car 4 moves along the first rail (drive rail 3a) and a second wheel (wheels 21a and drive wheels 21b) that rolls in contact with the other of the guide surfaces of the first rail (drive rail 3a) when the car 4 moves along the first rail (drive rail 3a). In this case, at least one of the first wheel and the second wheel is a drive wheel. As described above, moving in the up-down direction by wheel drive enables initial cost to be lowered as compared to a linear motor-type system.

In the present disclosure, the car 4 may include a third wheel (one horizontal movement drive wheel 28) and a fourth wheel (another horizontal movement drive wheel 28). When the car 4 moves along the first path, each of the third wheel (one horizontal movement drive wheel 28) and the fourth wheel (another horizontal movement drive wheel 28) does not come into contact with either the first rail (drive rail 3a) or the second rail (guide rails 3b and 3c). When the car 4 moves along the second path, each of the third wheel (one horizontal movement drive wheel 28) and the fourth wheel (another horizontal movement drive wheel 28) rolls in contact with the third rail (horizontal rail 3e2). At least one of the third wheel (one horizontal movement drive wheel 28) and the fourth wheel (another horizontal movement drive wheel 28) is a drive wheel. In this manner, by driving wheels provided separately from the wheels for moving in the up-down direction, the car 4 can be moved in the horizontal direction with a simple configuration. Accordingly, initial cost can be lowered as compared to a linear motor-type system.

The drive wheel that is at least one of the first wheel and the second wheel and the drive wheel that is at least one of the third wheel and the fourth wheel may be driven by a shared power source. The power source may be an electric motor. Sharing the power source enables the number of power sources to be reduced. Therefore, reduction in weight and cost can be achieved.

In the present embodiment, the set including the first self-boosting link 24 and the second self-boosting link 25 and the set including the first pressing-force averaging link 22 and the second pressing-force averaging link 23 constitute a bilaterally symmetrical structure with respect to the drive rail 3a. Therefore, compared to a bilaterally asymmetrical structure, robustness is improved and a greater imbalance due to passengers or cargo in the cab 5 can be tolerated.

In the present embodiment, the self-propelled elevator further includes a support section (first pressing-force averaging link 22, second pressing-force averaging link 23, first self-boosting link 24, and second self-boosting link 25) which supports the first wheel and the second wheel (wheels 21a and drive wheels 21b). As shown in FIG. 7, when the rotating section (upper rails 3b1 and 3c1) rotates when the movement path of the car 4 is switched from the first path to the second path, due to the rotating section (upper rails 3b1 and 3c1) coming into contact with the support section (at least one of first pressing-force averaging link 22, second pressing-force averaging link 23, first self-boosting link 24, and second self-boosting link 25), the first wheel (wheels 21a and drive wheels 21b) separates from one of the guide surfaces of the moving rail 3a1 and, at the same time, the second wheel (wheels 21a and drive wheels 21b) separates from the other guide surface of the moving rail 3a1. Accordingly, the pressing force with respect to the moving rail 3a1 can be released, the moving rail 3a1 can be moved, and the car 4 can move horizontally.

In a path switching method of the self-propelled elevator according to the present disclosure, the switching section (switching area 41) includes the moving rail 3a1, the first portion rail (lower rails 3b2 and 3c2), and the second portion rail (upper rails 3b1 and 3c1). The moving rail 3a1 can move to a connection position where the moving rail 3a1 connects to the first rail (drive rail 3a) when the car 4 moves to the first path and to a non-contact position where the car 4 does not come into contact with the moving rail 3a1 when the car 4 moves to the second path. The first portion rail (lower rails 3b2 and 3c2) can rotate and move to a rotation position where the first portion rail (lower rails 3b2 and 3c2) connects to the second rail (guide rails 3b and 3c) when the car 4 moves to the first path and to a rotation position where the first portion rail (lower rails 3b2 and 3c2) connects to the third rail (horizontal rail 3e2) when the car 4 moves to the second path. The second portion rail (upper rails 3b1 and 3c1) can rotate and move to a rotation position where the second portion rail (upper rails 3b1 and 3c1) connects to each of the second rail (guide rails 3b and 3c) and the first portion rail (lower rails 3b2 and 3c2) when the car 4 moves to the first path and to a rotation position where the second portion rail (upper rails 3b1 and 3c1) connects to the fourth rail (horizontal rail 3e1) when the car 4 moves to the second path.

In the path switching method of the self-propelled elevator according to the present disclosure, when switching the movement path of the car 4 from the first path to the second path, the first portion rail (lower rails 3b2 and 3c2) is rotated and moved from a rotation position where the first portion rail (lower rails 3b2 and 3c2) is parallel to the up-down direction to a rotation position where the first portion rail (lower rails 3b2 and 3c2) is parallel to the horizontal direction. Subsequently, the second portion rail (upper rails 3b1 and 3c1) is rotated and moved from a rotation position where the second portion rail (upper rails 3b1 and 3c1) is parallel to the up-down direction to a rotation position where the second portion rail (upper rails 3b1 and 3c1) is parallel to the horizontal direction. Subsequently, switching is performed in an order of moving the moving rail 3a1 from the connection position to the non-contact position.

In addition, in the path switching method of the self-propelled elevator according to the present disclosure, when switching the movement path of the car 4 from the second path to the first path, switching is performed in an order of: moving the moving rail 3a1 from the non-contact position to the connection position; subsequently rotating and moving the second portion rail (upper rails 3b1 and 3c1) from the rotation position where the second portion rail (upper rails 3b1 and 3c1) is parallel to the horizontal direction to the rotation position where the second portion rail (upper rails 3b1 and 3c1) is parallel to the up-down direction; and further subsequently rotating and moving the first portion rail (lower rails 3b2 and 3c2) from the rotation position where the first portion rail (lower rails 3b2 and 3c2) is parallel to the horizontal direction to the rotation position where the first portion rail (lower rails 3b2 and 3c2) is parallel to the up-down direction.

As shown in FIG. 1, a controller 15 is provided with respect to the hoistway 2. The controller 15 may be arranged in a machine room (not illustrated) above the hoistway 2 or arranged inside the hoistway 2. The controller 15 controls operation of devices provided in the switching area 41. For example, the controller 15 controls rotations of the lower rails 3b2, 3c2, 3b4, 3c4, 3b6, 3c6, 3b8, and 3c8 and the upper rails 3b1, 3c, 3b3, 3c3, 3b5, 3c5, 3b7, and 3c7 and movements of the moving rails 3a1, 3a2, 3a3, and 3a4. The controller 7 of the car 4 and the controller 15 of the hoistway 2 may work together to implement the path switching method of the self-propelled elevator according to the present disclosure.

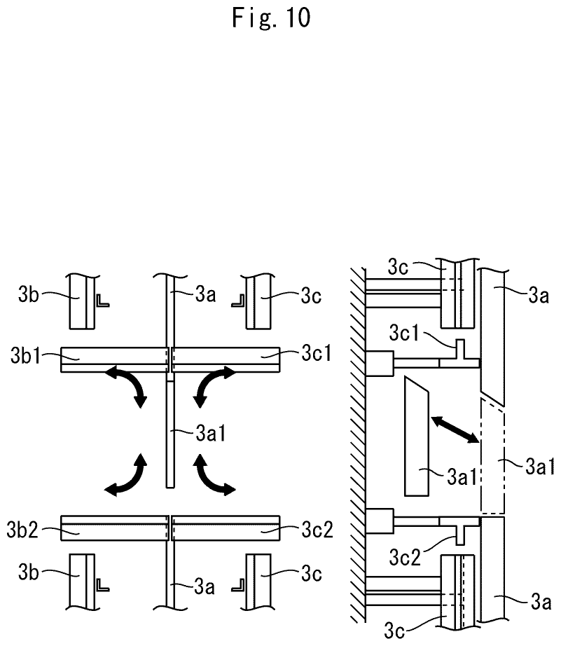

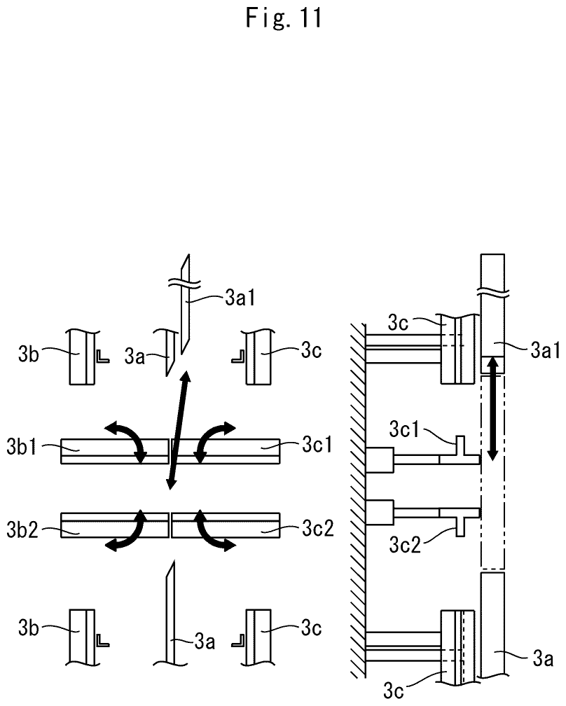

Next, a first modification will be described with reference to FIG. 10 and a second modification will be described with reference to FIG. 11. FIG. 10 is a rear view and a side view showing the first modification according to the first embodiment. FIG. 11 is a rear view and a side view showing the second modification according to the first embodiment. In the example shown in FIGS. 8 and 9 described earlier, a configuration is adopted in which the upper rails 3b1 and 3c1 and the lower rails 3b2 and 3c2 are rotated in the horizontal direction and the moving rail 3a1 is arranged in the gap between the upper rails 3b1 and 3c1 and in the gap between the lower rails 3b2 and 3c2. On the other hand, the first modification and the second modification adopt a configuration in which the moving rail 3a1 is not sandwiched between the upper rails 3b1 and 3c1 and between the lower rails 3b2 and 3c2.

In the first modification shown in FIG. 10, a distance between a center of rotation of the upper rails 3b1 and 3c1 and a center of rotation of the lower rails 3b2 and 3c2 is increased and a length of the moving rail 3a1 is reduced so that the moving rail 3acan pass between the upper rails 3b1 and 3c1 and the lower rails 3b2 and 3c2 when in the horizontal direction.

In the second modification shown in FIG. 11, the moving rail 3a1 is moved obliquely upward or obliquely downward instead of moving in a near-far direction.

By adopting the configuration of the first modification or the second modification described above, the need to provide the moving rail 3a1 with concave-convex shapes in accordance with the shapes of the upper rails 3b1 and 3c1 or the lower rails 3b2 and 3c2 can be eliminated, shapes can be simplified, and cost can be reduced.

In addition, with a configuration in which the moving rail 3al is inserted between the left and right lower rails 3b2 and 3c2, since a gap is required between the lower rails 3b2 and 3c2 and the moving rail 3a1, a gap or a difference in level can occur between the left lower rail 3b2 and the moving rail 3a1 during horizontal movement. Furthermore, during horizontal movement, a gap or a difference in level can occur between the moving rail 3a1 and the right lower rail 3c2. Passing over a gap or a difference in level at two locations over a distance of about the thickness of the moving rail 3a1 causes vibration. A similar problem occurs at the upper rails 3b1 and 3c1. In contrast, with the first modification or the second modification, since rotation is limited to that of the upper rails 3b1 and 3c1 and the lower rails 3b2 and 3c2, rotation is more controllable, and the gap or the difference in level between the upper rails 3b1 and 3c1 and the gap or the difference in level between the lower rails 3b2 and 3c2 can be reduced. In addition, since the gap or the difference in level only occurs at one location, vibration of the car 4 can be suppressed and ride quality can be improved.

### Second Embodiment

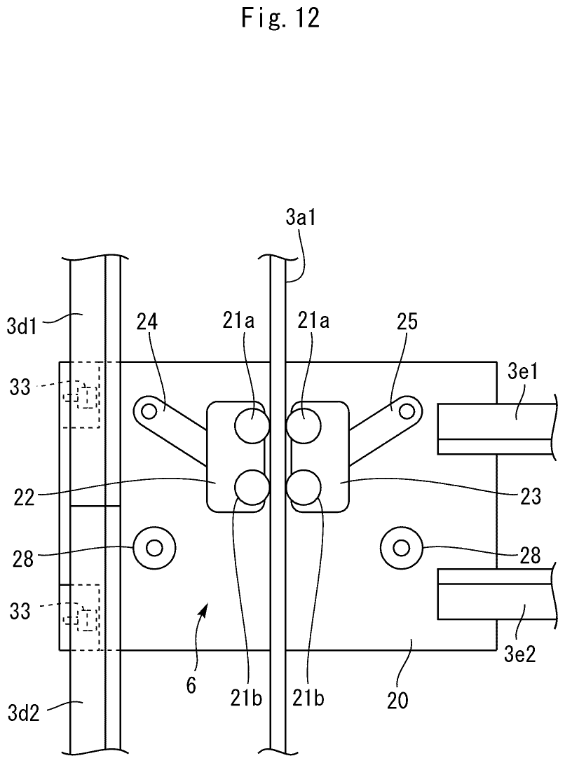

Next, while a second embodiment will be described with reference to FIGS. 12 to 15, the description will focus on differences from the first embodiment described above and common descriptions will be simplified or omitted. In addition, elements in common with or corresponding to elements described earlier will be denoted by same reference signs.

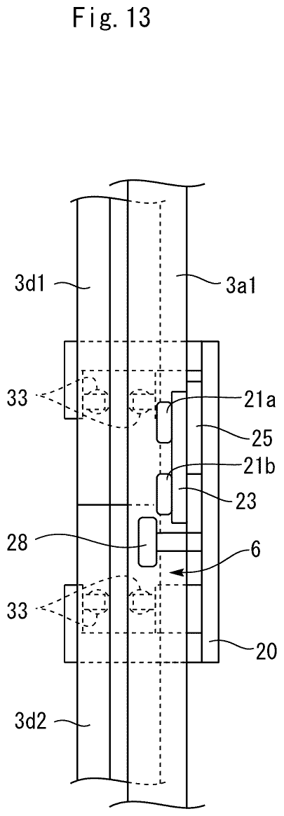

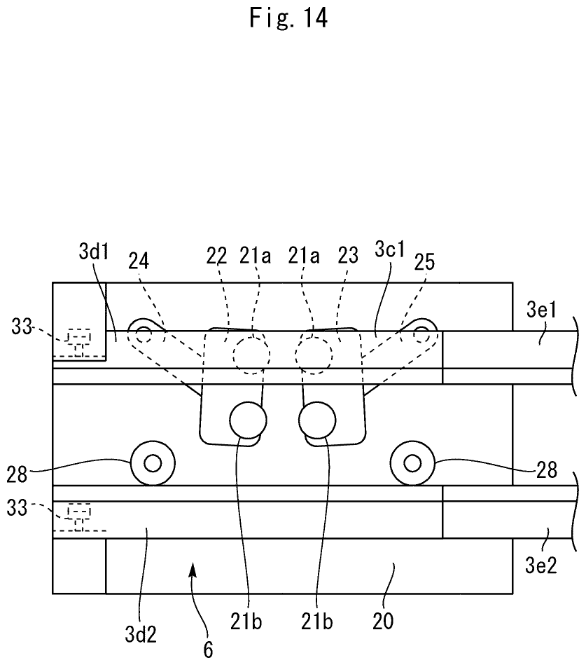

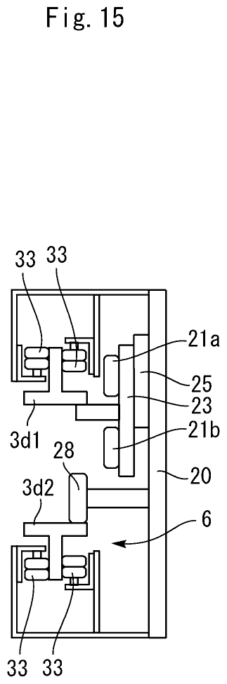

FIGS. 12 to 15 are diagrams showing a driving device and a relationship between a drive rail and a guide rail of an elevator system to which a driving device of a self-propelled elevator according to a second embodiment is applied. FIG. 12 is a rear view during up-down movement of the driving device of the self-propelled elevator according to the second embodiment. FIG. 13 is a side view during up-down movement of the driving device of the self-propelled elevator according to the second embodiment. FIG. 14 is a rear view during horizontal movement of the driving device of the self-propelled elevator according to the second embodiment. FIG. 15 is a side view during horizontal movement of the driving device of the self-propelled elevator according to the second embodiment.

In the first embodiment, one guide rail 3b and one guide rail 3c are each arranged on a left side and a right side of the car 4. In contrast, the second embodiment adopts a configuration in which only one guide rail is arranged on one side of the car 4. When the guide rail is only provided on one side, rotation of the car 4 with the up-down direction as a rotational axis readily occurs and a displacement of the car 4 may occur on the side where a guide rail is not provided. In consideration thereof, in place of the first tilt prevention roller 26 and the second tilt prevention roller 27, the car 4 of the self-propelled elevator according to the present embodiment includes a third tilt prevention roller 33 that is more robust than the first tilt prevention roller 26 and the second tilt prevention roller 27. The third tilt prevention roller 33 prevents the car 4 from rotating by adopting a configuration in which both surfaces of a guide plate of the guide rail are sandwiched by two rollers or two wide rollers.

In addition, in switching between up-down movement and horizontal movement, since there is only one rail, lengths of the upper rail 3d1 and the lower rail 3d2 must be extended as compared to the first embodiment. With this configuration, a position of the gap between the upper rail 3d1 and the horizontal rail 3e1 when horizontal and a position of the gap between the lower rail 3d2 and the horizontal rail 3e2 when horizontal do not coincide with the position of the moving rail 3a1. Therefore, in a similar manner to the first modification or the second modification of the first embodiment, a configuration is adopted in which the moving rail 3a1 is not sandwiched between the upper rail 3d1 and the horizontal rail 3e1 when horizontal and the lower rail 3d2 and the horizontal rail 3e2 when horizontal.

In the second embodiment, the configuration of the car 4, the configuration of the hoistway 2, and operations regarding switching of movement directions other than the above are the same as in the first embodiment. Since adopting such a configuration enables the number of guide rails to be reduced to one rail, a significant cost reduction can be achieved.

### Third Embodiment

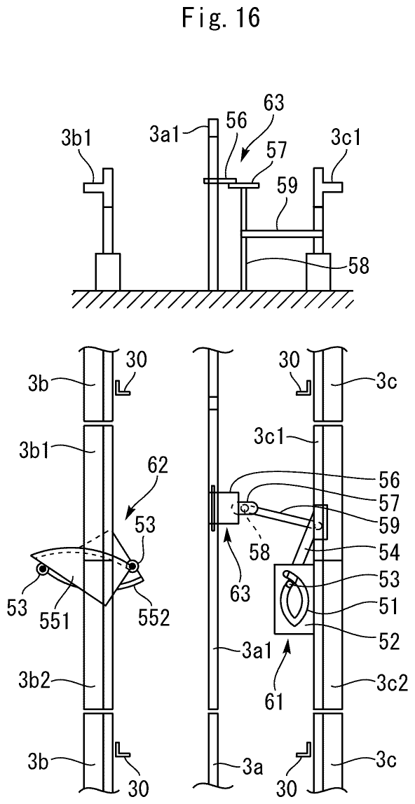

Next, while a third embodiment will be described with reference to FIGS. 16 to 19, the description will focus on differences from the first embodiment described above and common descriptions will be simplified or omitted. In addition, elements in common with or corresponding to elements described earlier will be denoted by same reference signs.

As described in the first and second embodiments, with a system in which movement directions are switched between the up-down direction and the horizontal direction by rotating the lower rails 3b2 and 3c2 or the lower rail 3d2 and the upper rails 3b1 and 3c1 or the upper rail 3d1 and moving the moving rail 3a1, the car 4 completely separates from the drive rail 3a during horizontal movement. When switching from horizontal movement to up-down movement, in the unlikely event that the moving rail 3a1 does not move properly and inadvertently causes the lower rails 3b2 and 3c2 or the lower rail 3d2 and the upper rails 3b1 and 3c1 or the upper rail 3d1 to rotate, there is a possibility that the pair of wheels 21a and the pair of drive wheels 21b will not be able to properly grip the moving rail 3a1 and the car 4 could become dislodged from each rail. In order to more reliably avoid such a situation from occurring, mechanical constraints are desirably imposed so that the lower rails 3b2 and 3c2 or the lower rail 3d2, the upper rails 3b1 and 3c1 or the upper rail 3d1, and the moving rail 3a1 can only operate in a correct order.

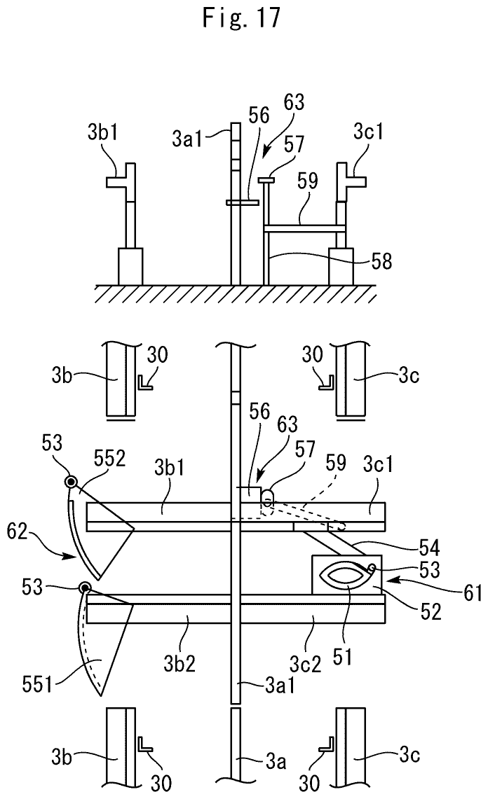

FIGS. 16 and 17 show a malfunction prevention mechanism as mechanical constraints provided with respect to the structure of the hoistway 2 shown in FIGS. 8 and 9 according to the first embodiment. FIG. 16 is a front view and a top view showing a malfunction prevention mechanism as mechanical constraints in the up-down direction according to the third embodiment. FIG. 17 is a front view and a top view showing a malfunction prevention mechanism as mechanical constraints in the horizontal direction according to the third embodiment. The mechanism that provides mechanical constraints is made up of the three mechanisms below.

A malfunction prevention mechanism 61 that is a first mechanism is provided between the lower rail 3c2 and the upper rail 3c1 and places a constraint on an order of rotation. The malfunction prevention mechanism 61 is illustrated on a right-side guide rail in FIGS. 16 and 17. The malfunction prevention mechanism 61 includes a plate 52 fixed to the lower rail 3c2. The plate 52 is provided with a slit 51 made up of two mutually opposite arc-shaped grooves. Fixed to the upper rail 3c1 is a rod-shaped member 54 one end of which is fixed to the upper rail 3c1 and another end is equipped with a roller 53 that corresponds to a projection capable of relatively moving inside the slit 51. Note that the mechanism provided on the left-side guide rail in FIGS. 16 and 17 is a malfunction prevention mechanism 62 that is an example of a separate structure of the first malfunction prevention mechanism 61 and will be described later.

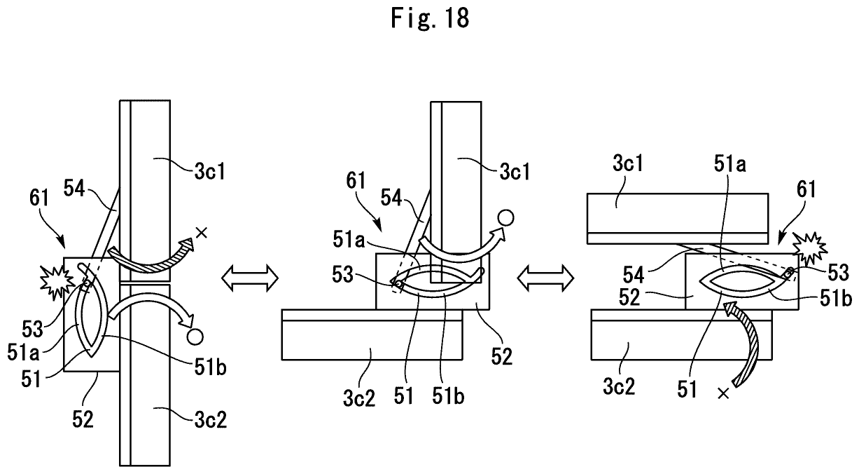

FIG. 18 is a diagram showing an operation of mechanical constraints on the upper rail 3c1 and the lower rail 3c2 by the malfunction prevention mechanism 61 according to the third embodiment. A correct order of operations when the lower rails 3b2 and 3c2 and the upper rails 3b1 and 3c1 transition from the up-down direction to the horizontal direction is: (1) lower rails 3b2 and 3c2 rotate; and (2) upper rails 3b1 and 3c1 rotate. Operations in the correct order will be described. First, since the upper rails 3b1 and 3c1 do not rotate, the rod-shaped member 54 fixed to the upper rail 3c1 and the roller 53 fixed to a tip of the rod-shaped member do not move. In this state, the lower rails 3b2 and 3c2 rotate. The plate 52 which is fixed to the lower rail 3c2 and which is provided with the slit 51 rotates together. The slit 51 includes an arc-shaped first groove 51a and an arc-shaped second groove 51b. The first groove 51a extends along an arc centered on a rotational axis of the lower rail 3c2 that is the first portion rail. When the lower rail 3c2 rotates, the roller 53 provided on the rod-shaped member 54 passes through the first groove 51a in the slit 51.

Next, when the upper rails 3b1 and 3c1 rotate, the roller 53 moves from left to right in the second groove 51b in the slit 51. The second groove 51b extends along an arc centered on a rotational axis of the upper rail 3c1 that is the second portion rail in a state where the lower rail 3c2 that is the first portion rail is horizontal. The lower rails 3b2 and 3c2 and the upper rails 3b1 and 3c1 operate in reverse order of the above when making a transition from the horizontal direction to the up-down direction.

On the other hand, constraints on attempting to move in an incorrect order will be described. When the lower rails 3b2 and 3c2 and the upper rails 3b1 and 3c1 are in the up-down direction and the upper rails 3b1 and 3c1 attempt to rotate first unlike in the correct order, the following occurs. Compared to the slit 51 fixed to the lower rail 3c2 which is more or less arranged in the up-down direction despite having an arc shape, since the rod-shaped member 54 fixed to the upper rail 3c1 and the roller 53 attempt to move in the horizontal direction, the slit 51 and the roller 53 come into contact and interfere with each other and rotation of the upper rails 3b1 and 3c1 is prevented. In addition, when the lower rails 3b2 and 3c2 and the upper rails 3b1 and 3c1 are in the horizontal direction and the lower rails 3b2 and 3c2 attempt to rotate first unlike in the correct order, since the slit 51 and the roller 53 come into contact and interfere with each other in a similar manner, rotation of the lower rails 3b2 and 3c2 is prevented.

Note that in the structure of the malfunction prevention mechanism 61 described above, if the roller 53 is tilted for some reason or if debris gets caught in the slit 51, a failure that prevents the roller 53 from moving may occur. A mechanism that solves this problem is a malfunction prevention mechanism 62 which is provided on the left-side guide rail in FIGS. 16 and 17 and which represents an example of a separate structure.

As shown in FIGS. 16 and 17, in the malfunction prevention mechanism 62 according to the example of a separate structure, a first fan-shaped member 551 is fixed to the lower rail 3b2. A roller 53 corresponding to a columnar projection is fixed to an end of the first fan-shaped member 551. A second fan-shaped member 552 is fixed to the upper rail 3b1. The roller 53 corresponding to a columnar projection is fixed to an end of the second fan-shaped member 552. When the upper rail 3b1 and the lower rail 3b2 are parallel to the up-down direction, the first fan-shaped member 551 and the second fan-shaped member 552 are arranged so as to overlap with each other.

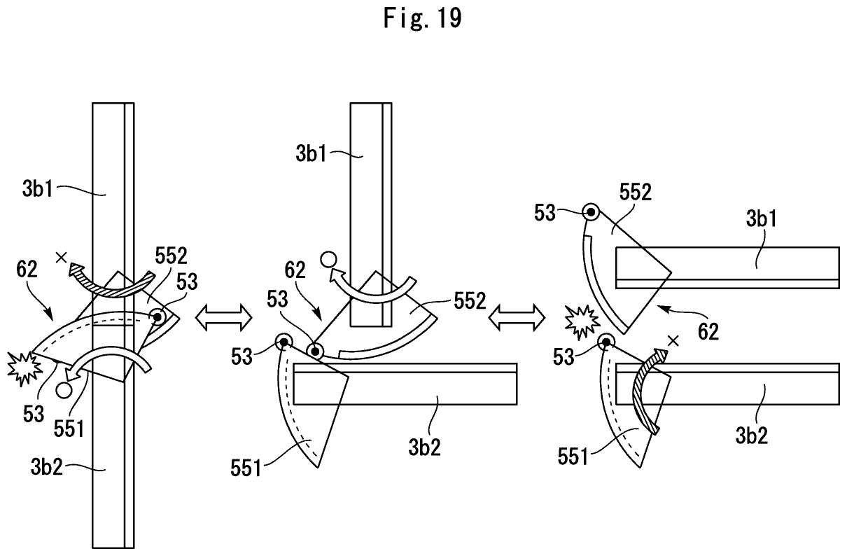

FIG. 19 is a diagram showing an operation of mechanical constraints on the upper rail 3b1 and the lower rail 3b2 by the malfunction prevention mechanism 62 according to the third embodiment. When the lower rail 3b2 and the upper rail 3b1 transition from the up-down direction to the horizontal direction, since the roller 53 of the second fan-shaped member 552 of the upper rail 3b1 and the first fan-shaped member 551 of the lower rail 3b2 come into contact and interfere with each other, the upper rails 3b1 and 3c1 are unable to move while the lower rails 3b2 and 3c2 are able to rotate. When rotation of the lower rails 3b2 and 3c2 ends, a space where the roller 53 of the second fan-shaped member 552 of the upper rail 3b1 can move becomes available and the upper rails 3b1 and 3c1 rotate. When the lower rails 3b2 and 3c2 and the upper rails 3b1 and 3c1 transition from the horizontal direction to the up-down direction, since the roller 53 of the first fan-shaped member 551 of the lower rail 3b2 comes into contact and interferes with the second fan-shaped member 552 of the upper rail 3b1, the operations cannot be performed in a wrong order and rotations are only possible in the order of the rotation of the upper rails 3b1 and 3c1 and the rotation of the lower rails 3b2 and 3c2. By using the first fan-shaped member 551 and the second fan-shaped member 552 described above, a slit is no longer present and the problem of the roller 53 hardening due to foreign objects or the like and the rail becoming incapable of rotating no longer occurs.

Next, a malfunction prevention mechanism 63 which is the second mechanism and which places constraints on an operation order of the upper rails 3b1 and 3cand the moving rail 3a1 will be described. As shown in FIGS. 16 and 17, in the malfunction prevention mechanism 63, a plate-like first restricting member 56 is mounted to the moving rail 3a1 in a portion opposing the wall of the hoistway 2. The first restricting member 56 may be directly mounted to the moving rail 3a1. Alternatively, the first restricting member 56 may be mounted to a mechanism that moves the moving rail 3a1. A round bar 58 that is a rod-shaped member rotatable around the longitudinal direction as an axis is installed in the hoistway 2. A rectangular or oval second restricting member 57 is fixed to a tip of the round bar 58. The rectangular or oval second restricting member 57 which is fixed to the tip of the round bar 58 can come into contact with the first restricting member 56 from a position closer to the wall of the hoistway 2 than the first restricting member 56 which is fixed to the moving rail 3a1. In addition, a rotation of the round bar 58 and the rotation of the upper rails 3b1 and 3c1 are configured to be synchronized via a belt 59 and the like. As shown in FIG. 16, when the upper rails 3b1 and 3c1 are in the up-down direction, a long-side direction of the rectangular or oval second restricting member 57 which is fixed to the tip of the round bar 58 is arranged to be perpendicular to the moving rail 3a1.

By adopting such a configuration, as shown in FIG. 16, when the upper rails 3b1 and 3c1 are in the up-down direction, the rectangular or oval second restricting member 57 and the first restricting member 56 provided on the moving rail 3al come into contact and interfere with each other and the moving rail 3a1 can no longer be moved from the connection position to the non-contact position. In contrast, as shown in FIG. 17, when the upper rails 3b1 and 3c1 are in the horizontal direction, a short-side direction of the rectangular or oval second restricting member 57 becomes perpendicular to the moving rail 3a1, the rectangular or oval second restricting member 57 and the first restricting member 56 fixed to the moving rail 3a1 no longer come into contact and interfere with each other and the moving rail 3a1 can be moved from the connection position to the non-contact position.

The third mechanism is a mechanism for preventing the lower rails 3b2 and 3c2 or the upper rails 3b1 and 3c1 from rotating before the moving rail 3a1 from the state of horizontal movement shown in FIG. 17. In FIG. 17, the pair of upper rails 3b1 and 3c1 and the pair of lower rails 3b2 and 3c2 are parallel to the horizontal direction. In addition, the moving rail 3a1 at a non-contact position is arranged between the pair of upper rails 3b1 and 3c1. Furthermore, the moving rail 3a1 at the non-contact position is arranged between the pair of lower rails 3b2 and 3c2. A gap between the lower rails 3b2 and 3c2 and the moving rail 3a1 and a gap between the upper rails 3b1 and 3c1 and the moving rail 3a1 are minute. In such a state, since the lower rails 3b2 and 3c2 and the upper rails 3b1 and 3c1 come into contact and interfere with the moving rail 3a1, the rails cannot rotate. The moving rail 3a1 must first move from the non-contact position to the connection position. Subsequently, the upper rails 3b1 and 3c1 become rotatable and, subsequently, the lower rails 3b2 and 3c2 become rotatable.

Due to the three mechanisms that constitute mechanical constraints, when the car 4 transitions from up-down movement to horizontal movement, an operation order of:
(1) rotation of the lower rails 3b2 and 3c2 from the up-down direction to the horizontal direction;
(2) rotation of the upper rails 3b1 and 3c1 from the up-down direction to the horizontal direction; and
(3) movement of the moving rail 3afrom the connection position to the non-contact position
   is more reliably secured.

In addition, when the car 4 transitions from horizontal movement to up-down movement, an operation order of:
(1) movement of the moving rail 3a1 from the non-contact position to the connection position;
(2) rotation of the upper rails 3b1 and 3c1 from the horizontal direction to the up-down direction; and
(3) rotation of the lower rails 3b2 and 3c2 from the horizontal direction to the up-down direction
   is more reliable secured.

As described above, the self-propelled elevator according to the present disclosure may further include a malfunction prevention mechanism. The malfunction prevention mechanism imposes mechanical constraints when switching the movement path of the car 4 from the first path to the second path so that switching can only be performed in an order of: rotating and moving the first portion rail (lower rails 3b2 and 3c2) from the rotation position where the first portion rail (lower rails 3b2 and 3c2) is parallel to the up-down direction to the rotation position where the first portion rail (lower rails 3b2 and 3c2) is parallel to the horizontal direction; subsequently rotating and moving the second portion rail (upper rails 3b1 and 3c1) from the rotation position where the second portion rail (upper rails 3b1 and 3c1) is parallel to the up-down direction to the rotation position where the second portion rail (upper rails 3b1 and 3c1) is parallel to the horizontal direction; and subsequently moving the moving rail from the connection position to the non-contact position.

In addition, the malfunction prevention mechanism imposes mechanical constraints when switching the movement path of the car 4 from the second path to the first path so that switching can only be performed in an order of: moving the moving rail 3a1 from the non-contact position to the connection position; subsequently rotating and moving the second portion rail (upper rails 3b1 and 3c1) from the rotation position where the second portion rail (upper rails 3b1 and 3c1) is parallel to the horizontal direction to the rotation position where the second portion rail (upper rails 3b1 and 3c1) is parallel to the up-down direction; and further subsequently rotating and moving the first portion rail (lower rails 3b2 and 3c2) from the rotation position where the first portion rail (lower rails 3b2 and 3c2) is parallel to the horizontal direction to the rotation position where the first portion rail (lower rails 3b2 and 3c2) is parallel to the up-down direction.

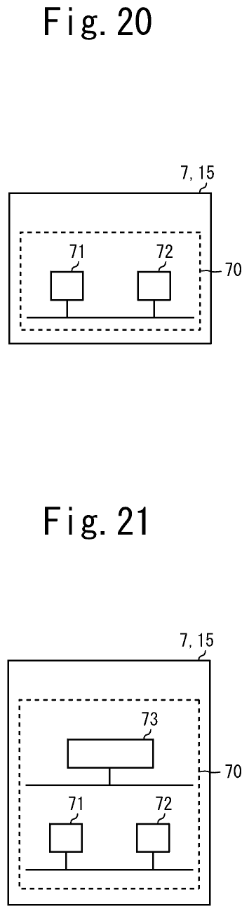

FIG. 20 is a diagram showing an example of hardware resources of the controller 7 of the car 4 and the controller 15 of the hoistway 2. Each of the controller 7 and the controller 15 may be equipped with a processing circuitry 70 including a processor 71 and a memory 72. Each of the controller 7 and the controller 15 may achieve functions included in each of the controller 7 and the controller 15 by executing, with the processor 71, a program stored in the memory 72. A semiconductor memory or the like can be adopted as the memory 72.

FIG. 21 is a diagram showing another example of hardware resources of the controller 7 of the car 4 and the controller 15 of the hoistway 2. In the example shown in FIG. 21, each of the controller 7 and the controller 15 is equipped with the processing circuitry 70 including the processor 71, the memory 72, and dedicated hardware 73. FIG. 21 shows an example of achieving, with the dedicated hardware 73, a part of the functions included in each of the controller 7 and the controller 15. All of the functions included in each of the controller 7 and the controller 15 may be achieved by the dedicated hardware 73. As the dedicated hardware 73, a single circuit, a combined circuit, a programmed processor, a parallel-programmed processor, an ASIC, an FPGA, or a combination thereof can be adopted.

### Industrial Applicability

The self-propelled elevator and the method of switching paths of the self-propelled elevator according to the present disclosure can be used in, for example, self-propelled elevators provided in buildings.

### REFERENCE SIGNS LIST

1 elevator
2 hoistway
2a hoistway
2b hoistway
3a drive rail
3a1 moving rail
3a2 moving rail
3a3 moving rail
3a4 moving rail
3b guide rail
3b1 upper rail
3b2 lower rail
3b3 upper rail
3b4 lower rail
3b5 upper rail
3b6 lower rail
3b7 upper rail
3c guide rail
3c upper rail
3c2 lower rail
3c3 upper rail
3c4 lower rail
3c5 upper rail
3c6 lower rail
3c7 upper rail
3c8 lower rail
3d1 upper rail
3d2 lower rail
3e1 horizontal rail
3e2 horizontal rail
3e3 horizontal rail
3e4 horizontal rail
4 car
5 cab
6 driving device
7 controller
8 platform
9 bottom panel
10 guide plate
11 guide surface
15 controller
20 support body
21a wheel
21b drive wheel
22 first pressing-force averaging link
23 second pressing-force averaging link
24 first self-boosting link
25 second self-boosting link
26 first tilt prevention roller
27 second tilt prevention roller
28 horizontal movement drive wheel
30 rail support member
31 motor
32 four-section link
33 third tilt prevention roller
34 convex part
35 concave part
36 concave part
41 switching area
51 slit
51a first groove
51b second groove
52 plate
54 rod-shaped member
56 first restricting member
57 second restricting member
58 round bar
59 belt
61 malfunction prevention mechanism
62 malfunction prevention mechanism
63 malfunction prevention mechanism
70 processing circuitry
71 processor
72 memory
73 dedicated hardware
551 first fan-shaped member
552 second fan-shaped member

1. A self-propelled elevator, comprising:
a car;
a first path which is used when the car moves in an up-down direction;
a second path which is used when the car moves in a horizontal direction;
a first rail which is provided along a longitudinal direction of the first path and along which the car slides;
a second rail which is provided along the longitudinal direction of the first path and which guides movement of the car;
a third rail which is provided along a longitudinal direction of the second path and along which the car slides; and
a switching section which is provided at a position where the first path and the second path intersect, wherein
the switching section includes a moving rail and a rotating section,
the moving rail can move to a position where the moving rail connects to the first rail when the car moves to the first path and to a position where the car does not come into contact with the moving rail when the car moves to the second path, and
the rotating section can rotate and move to a rotation position where the rotating section connects to the second rail when the car moves to the first path and to a rotation position where the rotating section connects to the third rail when the car moves to the second path.

2. The self-propelled elevator according to claim 1, further comprising:
a fourth rail provided along the longitudinal direction of the second path above the third rail, wherein
the rotating section includes a first portion rail and a second portion rail,
the first portion rail can rotate and move to a rotation position where the first portion rail connects to the second rail when the car moves to the first path and to a rotation position where the first portion rail connects to the third rail when the car moves to the second path, and
the second portion rail can rotate and move to a rotation position where the second portion rail connects to each of the second rail and the first portion rail when the car moves to the first path and to a rotation position where the second portion rail connects to the fourth rail when the car moves to the second path.

3. The self-propelled elevator according to claim 1, wherein
the car includes:
a first wheel which rolls in contact with one guide surface of the first rail when the car moves along the first rail; and
a second wheel which rolls in contact with another guide surface of the first rail when the car moves along the first rail, and
at least one of the first wheel and the second wheel is a drive wheel.

4. The self-propelled elevator according to claim 3, wherein
the car includes a third wheel and a fourth wheel,
when the car moves along the first path, each of the third wheel and the fourth wheel does not come into contact with either the first rail or the second rail,
when the car moves along the second path, each of the third wheel and the fourth wheel rolls in contact with the third rail, and
at least one of the third wheel and the fourth wheel is a drive wheel.

5. The self-propelled elevator according to claim 4, further comprising:
a power source, wherein
the drive wheel that is at least one of the first wheel and the second wheel and the drive wheel that is at least one of the third wheel and the fourth wheel are driven by the power source that is shared.

6. The self-propelled elevator according to claim 3, further comprising:
a support section which supports the first wheel and the second wheel, wherein
when the rotating section rotates when a movement path of the car is switched from the first path to the second path, due to the rotating section coming into contact with the support section, the first wheel separates from the one guide surface of the moving rail and, at the same time, the second wheel separates from the other guide surface of the moving rail.

7. A method of switching paths of a self-propelled elevator, the self-propelled elevator including:
a car;
a first path which is used when the car moves in an up-down direction;
a second path which is used when the car moves in a horizontal direction;
a first rail which is provided along a longitudinal direction of the first path and along which the car slides;
a second rail which is provided along the longitudinal direction of the first path and which guides movement of the car;
a third rail which is provided along a longitudinal direction of the second path and along which the car slides;
a fourth rail which is provided along the longitudinal direction of the second path above the third rail; and
a switching section which is provided at a position where the first path and the second path intersect,
the switching section including a moving rail, a first portion rail, and a second portion rail,
the moving rail being able to move to a connection position where the moving rail connects to the first rail when the car moves to the first path and to a non-contact position where the car does not come into contact with the moving rail when the car moves to the second path,
the first portion rail being able to rotate and move to a rotation position where the first portion rail connects to the second rail when the car moves to the first path and to a rotation position where the first portion rail connects to the third rail when the car moves to the second path,
the second portion rail being able to rotate and move to a rotation position where the second portion rail connects to each of the second rail and the first portion rail when the car moves to the first path and to a rotation position where the second portion rail connects to the fourth rail when the car moves to the second path, wherein
when switching a movement path of the car from the first path to the second path, switching is performed in an order of:
rotating and moving the first portion rail from a rotation position where the first portion rail is parallel to the up-down direction to a rotation position where the first portion rail is parallel to the horizontal direction;
subsequently rotating and moving the second portion rail from a rotation position where the second portion rail is parallel to the up-down direction to a rotation position where the second portion rail is parallel to the horizontal direction; and
subsequently moving the moving rail from the connection position to the non-contact position, and
when switching the movement path of the car from the second path to the first path, switching is performed in an order of:
moving the moving rail from the non-contact position to the connection position;
subsequently rotating and moving the second portion rail from the rotation position where the second portion rail is parallel to the horizontal direction to the rotation position where the second portion rail is parallel to the up-down direction; and
further subsequently rotating and moving the first portion rail from the rotation position where the first portion rail is parallel to the horizontal direction to the rotation position where the first portion rail is parallel to the up-down direction.

8. The method of switching paths of a self-propelled elevator according to claim 7, wherein the self-propelled elevator further includes:
a malfunction prevention mechanism, and
when switching the movement path of the car from the first path to the second path, the malfunction prevention mechanism applies mechanical constraints so that switching can only be performed in an order of:
rotating and moving the first portion rail from the rotation position where the first portion rail is parallel to the up-down direction to the rotation position where the first portion rail is parallel to the horizontal direction;
subsequently rotating and moving the second portion rail from the rotation position where the second portion rail is parallel to the up-down direction to the rotation position where the second portion rail is parallel to the horizontal direction; and
subsequently moving the moving rail from the connection position to the non-contact position, and
when switching the movement path of the car from the second path to the first path, the malfunction prevention mechanism applies mechanical constraints so that switching can only be performed in an order of:
moving the moving rail from the non-contact position to the connection position;
subsequently rotating and moving the second portion rail from the rotation position where the second portion rail is parallel to the horizontal direction to the rotation position where the second portion rail is parallel to the up-down direction; and
further subsequently rotating and moving the first portion rail from the rotation position where the first portion rail is parallel to the horizontal direction to the rotation position where the first portion rail is parallel to the up-down direction.

9. The method of switching paths of a self-propelled elevator according to claim 8, wherein the malfunction prevention mechanism includes:
a member which is fixed to the first portion rail and which is provided with an arc-shaped first groove and an arc-shaped second groove; and
a projection which is fixed to the second portion rail and which is relatively movable along the first groove and the second groove with respect to the first groove and the second groove,
the first groove extends along an arc centered on a rotational axis of the first portion rail, and
the second groove extends along an arc centered on a rotational axis of the second portion rail in a state where the first portion rail is parallel to the horizontal direction.

10. The method of switching paths of a self-propelled elevator according to claim 8, wherein the malfunction prevention mechanism includes:
a first fan-shaped member which is fixed to the first portion rail and which is provided with a columnar projection at one end; and
a second fan-shaped member which is fixed to the second portion rail and which is provided with a columnar projection at one end,
when the first portion rail and the second portion rail are parallel to the up-down direction, the first fan-shaped member and the second fan-shaped member are arranged so as to overlap with each other, the first portion rail is rotatable, and rotation of the second portion rail is prevented due to the projection of the second fan-shaped member coming into contact with the first fan-shaped member, and
when the first portion rail and the second portion rail are parallel to the horizontal direction, the second portion rail is rotatable, and rotation of the first portion rail is prevented due to the projection of the first fan-shaped member coming into contact with the second fan-shaped member.

11. The method of switching paths of a self-propelled elevator according to claim 8, wherein the malfunction prevention mechanism includes:
a first restricting member which is mounted to the moving rail or to a mechanism that moves the moving rail; and
a second restricting member which is provided at a tip of a rod-shaped member that rotates in synchronization with a rotation of the second portion rail,
when the second portion rail is parallel to the up-down direction, a movement of the moving rail from the connection position to the non-contact position is prevented due to the first restricting member coming into contact with the second restricting member, and
when the second portion rail is parallel to the horizontal direction, the first restricting member does not come into contact with the second restricting member and the moving rail is movable from the connection position to the non-contact position.

12. The method of switching paths of a self-propelled elevator according to claim 8, wherein the self-propelled elevator includes:
a pair of the first portion rails and a pair of the second portion rails, and
when the pair of the first portion rails and the pair of the second portion rails are parallel to the horizontal direction, the moving rail is arranged between the pair of the first portion rails and the moving rail is arranged between the pair of the second portion rails.
